(19) United States
(12) Patent Application Publication
(10) Pub. No.: US 2006/0065293 A1
(43) Pub. Date: Mar. 30, 2006

(54) Procedure for blocked drain line on asphalt trailer

(75) Inventor: Thomas L. Sargent, Fairview, PA (US)

Correspondence Address: Attn: William J. Davis, Esq.;GAF MATERIALS CORPORATION, Legal Department, 1361 Alps Road, Building No. 8, Wayne, NJ, 07470, US

(73) Assignee: BUILDING MATERIALS INVESTMENT CORPORATION

(21) Appl. No.: 10/956,002

(22) Filed: Sep. 30, 2004

(51) Int. Cl. B08B 3/00; B08B 3/12

(52) U.S. Cl. 134/34; 134/198

(57) ABSTRACT

An apparatus and method for dislodging a solidified plug formed in the delivery line of hot asphalt blocking the delivery of the flowable asphalt to a site close to or remote from the site of application to a surface to be fixed or coated with the flowable hot asphalt.

### BACKGROUND OF THE INVENTION

1. Field of the Invention

This invention generally relates to asphalt distribution and more particularly for a procedure for unblocking drain lines on asphalt distributors.

2. Description of the Related Art

It is well known in the industry that asphalt in the liquid phase used on road surfaces and roof tops adhere to these surfaces and form a coating layer when it solidifies. It is also known that asphalt adheres to surfaces of the equipment used to handle and transport it, and under certain conditions, can build up in the pipes/hoses rendering the delivery to the sites of application unsuitable for coating purposes.

Asphalt handling equipment conventionally includes a tank, a pump, a spray bar and a plumbing system for delivering asphalt from the tank to the spray bar which then spreads the asphalt on the surfaces desired to be coated. The tank, pump and spray bar along with the plumbing system are conventionally supported directly by a vehicle, such as a truck, or supported by a detachable trailer behind the vehicle. The plumbing system's main function is to circulate the asphalt in the tank during initial asphalt, heating, spraying the asphalt and circulating the asphalt through the spray bar while not spraying to prevent freezing of the asphalt therein.

Keeping the asphalt in a flowable state has been a serious issue and problem in the industry both during transportation and its application to the site of delivery. The prior art has provided various solutions to the problem which include the following.

U.S. Pat. No. 4,620,645 is directed to an asphalt melting and dispensing apparatus wherein a jacketed flexible hose having a controlled circulating system for circulating an oil heating medium is used for heating the asphalt in a kettle to maintain the asphalt within the flexible hose in a fluid state during periods of non-use.

U.S. Pat. No. 4,695,186 discloses an asphalt handling apparatus which includes a gas burner to keep the asphalt in a flowable state.

U.S. Pat. No. 4,944,632 relates to a device for dispensing asphalt repair materials comprising a hopper compartment for transporting and dispensing asphalt mix materials. A separate tack oil tank is provided with an internal circulation system for maintaining liquid tack oils in an emulsified state.

U.S. Pat. No. 5,366,308 discloses a hot asphalt transfer and application device to transfer hot asphalt to roof surfaces via a hose wherein said hose can be 500 feet long. The device comprises:

heating elements disposed within a storage tank and heating wires wrapped around the inner tube members of the hoses which keep the asphalt material in a liquid form during operation of the device.

U.S. Pat. No. 5,607,254 is directed to a method and apparatus for automatically controlling the temperature of an asphalt paver wherein:

the control senses the screed temperature and compares the screed temperature to a lower set point, the control causes the fuel to dispense into a combination chamber and subsequently causes the fuel to ignite in order to heat the screed.

U.S. Pat. No. 5,974,227 relates to a hot melt applicator with electrically heated hose. The hot melt applicator comprises:

a source of solid materials/asphalt,

a heater, in thermal relation with the source for heating the solid materials for the same to become flowable;

a movable, elongate conduit in fluid flow communication with the source;

a pump to move the flow of melted material into the elongated conduit;

an electric heating element in the conduit for heating the flowable heating material that is disposed in the conduit.

The use of the heater in the source and in the elongate conduit in the form of electric current are said to maintain flowability of the source material/asphalt so that the source material/asphalt remains spreadable during its application to a site.

U.S. Pat. No. 6,126,757 is directed to a method of releasing asphalt from equipment using surfactant solutions. The method comprises: diluting a concentrate with about 4-50 parts water to one part of concentrate and haulting, such as spraying, rolling, or brushing the diluted concentrate on the equipment, and coating the equipment prior to its coming into contact with the asphalt. The concentrate comprises a fatty acid amide, a fatty acid neutralizer with an alkyl- or alkanol- or mixed-type amine or ammonia.

U.S. Pat. No. 6,161,775 discloses a feed line assembly and asphalt circulation system for an asphalt distributor which comprises a coaxial feed line assembly that serves as heat exchanger to transfer heat from the delivery conduit to the return conduit and thereby prevents freezing the static asphalt in the return conduit during spraying mode.

As illustrated above, the prior art has made substantial improvements in the delivery of asphalt to the site of application in terms of maintaining the asphalt in flowable condition and preventing freezing of the asphalt prior to and during delivery. However, freezing the asphalt prior to and during delivery, the prior art does not provide a method of unplugging of the delivery exit from plugging the system. The present invention is to provide a solution when such system fails and the results in blockage which may cause serious operating problems and associated injury to operators.

### SUMMARY OF THE INVENTION

Once the blockage/freezing occurs in the delivery/tube exit, it must be resolved by removing the exit plug from the asphalt material safely and inexpensively so that the delivery of asphalt to the site could continue. The present invention is directed to a method and apparatus to achieve that goal.

The apparatus according to the present invention comprises:

a truck or attached vehicle containing hot asphalt or a heating means associated with hot asphalt to maintain the hot asphalt in a flowable state;

an exit or delivery port in direct or indirect communication with the hot asphalt contained in the truck;

a pressure device tank containing nitrogen or other inert, non-flammable materials, such as argon, connected to said exit port of the hot asphalt tank, when the exit delivery port is partially or substantially clogs said exit port thereby failing continuous delivery of said asphalt;

said pressure device being capable of unblocking/unfreezing said partially or substantially clogged exit delivery port.

In a method aspect the invention comprises dislodging a plug solidified in the exit port or extension hose emanating from the truck or trailer of an asphalt-containing truck or trailer, comprises:

closing the valve on the asphalt-containing truck or trailer;

opening the lid of the asphalt-containing tank or trailer;

attaching the pressure device coupling onto the drain line or hose of the pressure device;

setting the pressure device to zero psi;

closing the vent valve on the pressure device;

opening the truck valve or trailer asphalt valve;

starting and increasing the pressure of the inert, non-inflammatory gas up to 90 psi;

closing the vent valve on the inert, non-flammable source of gas;

opening the vent valve when removal of the solidified asphalt plug is achieved; and

removing the pressure device from the truck valve or trailer to allow the flow of said asphalt to the site of application

### BRIEF DESCRIPTION OF THE DRAWING

FIG. 1 is a schematic representation of an asphalt truck attached to which is a nitrogen tank with associated hoses, valves, regulators and gauges.

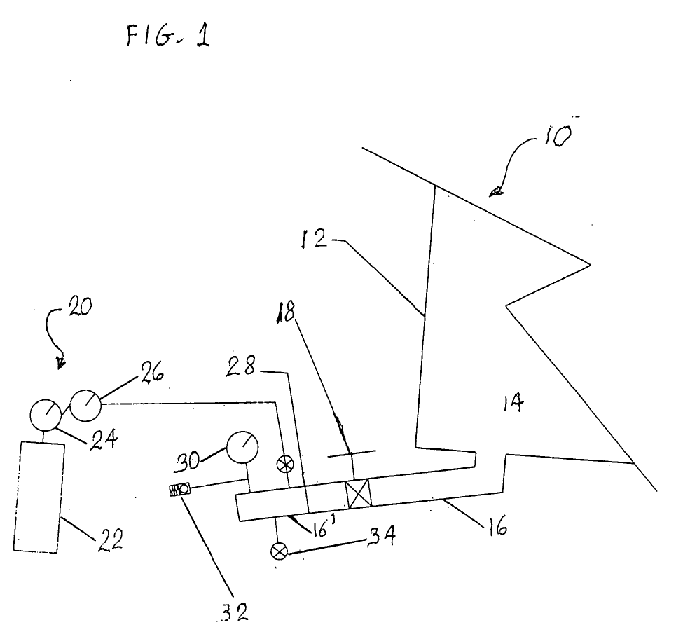

### DESCRIPTION OF THE PREFERRED EMBODIMENTS

The present invention is directed to unclogging drain lines in asphalt distributor trucks and trailers. Referring to the drawing, the asphalt distributor truck or trailer 10 comprises a tank 12 containing flowable asphalt or similar material 14 which are to be dispensed on road surfaces and roof tops which flowable asphalt or similar materials then solidify or freeze on the surfaces creating a protective seal against precipitation, such as rain or snow, from penetrating into the underlying surfaces. The tank is made of steel, or an alloy containing steel, to withstand the high temperatures of the asphalt or similar materials being in a flowable state. The tank 12 is conventionally equipped with a drain line or hose 16 to deliver the flowable material away from the tank for distribution to said surfaces. Accordingly, the drain line or hose may be short, such as a few inches, or it may be several feet up to 100 and 150 feet depending on the distance of the surface to be coated. At the end of the drain line or hose there is a valve 18 for opening and closing the flow of the flowable material emanating from the tank 12.

The exit port for the hot asphalt may have an extension hose 16′ attached thereto to transfer the hot asphalt from the asphalt-containing tank to a more remote site, such as a roof on the top of a building. In this case the pressure device is attached onto the remote end of the extension hose.

The pressure device 20 preferably attached to the asphalt containing tank 12, or to the extension hose 16′ when blockage/freezing occurs in the exit port.

The pressure device 20 is carried on a handcart carrying a cylinder having 50 to 80 cubic feet of nitrogen or other inert gas. The pressure device is provided with a coupling chain which attaches to the exit port and safely holds the pressure device to the exit port.

The pressure device 20 contains a nitrogen or other non-flammable gas in a tank 22. The tank is equipped with a valve 24 and regulator gauge 26 to controllably release one of said gases when unblocking of the asphalt-containing drain line or hose 16 is required.

The pressure device 20 further comprises a hose 28 extending from the regulator gauge 26 towards the truck valve. The end of the hose is equipped with a Camlock coupling 28 releasably attached to the truck valve 18.

The pressure device is further equipped with a gauge 30 to measure the pressure originating from the tank 22; a relief valve 32 to relieve the pressure in the pressure device; and a vent valve 34 which serves as a safety exit for overpressure.

The details of source materials in connection with the present invention are as follows.

Relief valve 32 supplied by Advanced Specialty Gas Equipment by Allied/Kunkle Valve Industries (S/N A0335549-1-1K) having a pressure/temperature limit of 3 to 400 psig/−60° F. to 300° F.;

Valve and Regulator Gauge 24 and 26 manufactured by Wika having 0-160 psig, operating temperature −40° F. to 140° F.;

Camplock Coupling 28 manufactured by Dixon, made of aluminum, maximum pressure 125 psig;

Drain line or hose 16 manufactured by Parker/Dayco under the tradename Dayco Hose;

Compressed nitrogen in cylinder 22 is widely available from suppliers, such as Chapman Gas, Erie, Pa. A having 40 ft.³ capacity.

The pressure device 20 is conveniently carried on a handcart equipped with chains to securely hold the nitrogen cylinder and associated items to attach the pressure device to the asphalt distributor tank or trailer.

The method of use of the pressure device 20 to dislodge a plug of asphalt from the drain line or hose 16 of the asphalt truck or trailer 10 comprises the steps of:

closing the valve 18 on the asphalt tank or trailer 10;

opening the lid on the asphalt tank or trailer;

attaching hose 16′ on pressure device 20 using the camlock coupling 28 onto drain line or hose 16 of the asphalt truck or trailer;

setting regulator gauge 26 on pressure device to zero pressure;

closing the vent valve 34 on hose 16′ of the pressure device;

opening the truck or trailer asphalt valve;

opening nitrogen supply valve 24;

starting nitrogen pressure using regulator gauge 26;

increasing nitrogen pressure up to 90 psi or until blockage is dislodged;

closing truck valve 18;

closing valve 24 on nitrogen tank;

opening vent valve 34 to bleed of pressure; and

removing pressure device 20 from truck valve or trailer 18.

The above description is intended in an illustrative rather than a restrictive sense. Variations may be apparent to persons skilled in the art without departing from the spirit and scope of the invention as defined by the claims set for the below.

PARTS LIST

| | |
|---|---|
| Distributor truck or trailer | 10 |
| Tank of truck or trailer | 12 |
| Asphalt or similar material | 14 |
| Drain line or hose on asphalt truck or trailer | 16 |
| Hose on pressure device 20 | 16′ |
| Valve for opening and closing the flow of asphalt | 18 |
| Pressure device | 20 |
| Tank of pressure device | 22 |
| Valve on nitrogen tank | 24 |
| Regulator gauge on pressure device | 26 |
| Camlock coupling | 28 |
| Gauge to measure pressure in system | 30 |
| Release valve in system | 32 |
| Vent valve in pressure device to release pressure in system | 34 |

What is claimed is:

1. An apparatus to dislodge a plug of asphalt solidified in the exit port of an asphalt-containing distributor truck comprising:
a tank containing an inert, non-flammable gas under pressure;
an exit port extending from said tank terminating in a coupling means, releasably attached to said exit port of said asphalt-containing distributor truck;
valve to open said pressure device of said inert, non-flammable gas from said tank;
regulator gauges associated with said pressure device, wherein said pressures are controlled in order to dislodge said solidified plug contained in said asphalt-containing distributor truck in order to restart the flow of asphalt from said distributor truck.

2. The apparatus of claim 1 wherein said inert, non-flammable gas is nitrogen.

3. The apparatus of claim 1 wherein said inert, non-flammable gas is argon.

4. The apparatus of claim 1 wherein said dislodge of the plug is to release said plug in order to restart the flow of said hot asphalt material.

5. The apparatus of claim 1 further comprising an extension hose emanating from the asphalt-containing tank to deliver the hot asphalt to a remote site wherein the pressure device is attached to the remote end of the extension hose.

6. An apparatus to dislodge a plug of asphalt solidified in the exit port of an asphalt-containing distribution tank having a pressure device comprising:
a tank containing an inert, non-flammable gas under pressure;
an exit port extending from said tank and terminating in a coupling means, releasably attached to said exit port of said asphalt-containing truck; and
a regulator gauge on said pressure device to controllably release said inert, non-flammable gas to dislodge said plug of the exit port of the asphalt-containing distributor tank.

7. A method to dislodge a plug of asphalt solidified in the exit port of an asphalt-containing distributor tank comprising the steps of:
a) providing a pressure device comprising:
a tank containing an inert, non-flammable gas under pressure;
a supply valve on said tank;
an exit port extending from said tank and terminating in a coupling means for releasable attachment to an exit port of an asphalt-containing truck;
a regulator gauge on the tank of the pressure device to release said inert, non-flammable gas;
a vent valve on the pressure device; and
b) attaching said pressure device to the exit port of said asphalt-containing truck using the coupling means;
c) setting the regulator gauge to zero pressure;
d) closing the vent valve on the pressure device;
e) opening said supply valve;
f) starting the flow of said inert, non-flammable gas;
g) increasing the flow of said inert, non-flammable gas up to a pressure of 90 psi or until said plug of asphalt is dislodged;
h) closing supply valve;
i) opening said vent valve to release pressure; and
j) removing said pressure device from said exit point of said asphalt-containing truck.

8. The method of claim 7 wherein said apparatus further comprises an extension hose emanating from said asphalt-containing tank to deliver the hot asphalt to a remote site wherein the pressure device is attached to the remote end of the extension hose.

9. The method of claim 7 wherein said inert, non-flammable gas is nitrogen.

10. The method of claim 7 wherein said inert, non-flammable gas is argon.

11. The method of claim 7 wherein said dislodge of said solidified plug is to release said plug from said exit port and putting it in the hot asphalt contained in the distributor tank to restart the flow of said hot asphalt.
